(19) United States
(12) Patent Application Publication
(10) Pub. No.: US 2024/0388148 A1
(43) Pub. Date: Nov. 21, 2024

(54) ROTOR MEMBER, ROTOR, ROTARY ELECTRIC MACHINE, BRUSHLESS MOTOR, AND METHOD FOR MANUFACTURING ROTOR MEMBER

(71) Applicant: Murata Manufacturing Co., Ltd., Nagaokakyo-shi (JP)

(72) Inventors: Mitsuhiro SAITO, Nagaokakyo-shi (JP); Daiki KISHIMOTO, Nagaokakyo-shi (JP); Ryosuke YAMAMOTO, Nagaokakyo-shi (JP); Takuya NANSAKA, Nagaokakyo-shi (JP); Kazuyoshi ISHIZUKA, Nagaokakyo-shi (JP); Hisato AMANO, Nagaokakyo-shi (JP); Mitsutoshi NATSUMEDA, Nagaokakyo-shi (JP)

(21) Appl. No.: 18/788,587

(22) Filed: Jul. 30, 2024

Related U.S. Application Data
(63) Continuation of application No. PCT/JP2023/022482, filed on Jun. 16, 2023.

(30) Foreign Application Priority Data
Oct. 24, 2022 (JP) 2022-169931

(51) Int. Cl. H02K 1/2733; H02K 15/03

(52) U.S. Cl. CPC H02K 1/2733; H02K 15/03

(57) ABSTRACT

A rotor member that includes: a soft magnetic body; and a hard magnetic body that is in contact with a peripheral surface of the soft magnetic body in a radial direction centered on the central axis, wherein a contact surface between the soft magnetic body and the hard magnetic body has a shape protruding in the radial direction entirely around the central axis such that a position of a minimum width of a portion forming the contact surface in the soft magnetic body in the radial direction is different from positions of a first end surface and a second end surface of the soft magnetic body, and positions of a third end surface and a fourth end surface of the hard magnetic body.

### CROSS REFERENCE TO RELATED APPLICATIONS

The present application is a continuation of International application No. PCT/JP2023/022482, filed Jun. 16, 2023, which claims priority to Japanese Patent Application No. 2022-169931, filed Oct. 24, 2022, the entire contents of each of which are incorporated herein by reference.

### TECHNICAL FIELD

The present disclosure relates to a rotor member used in a rotary electric machine, a rotor including a rotor member, a rotary electric machine including a rotor member, a brushless motor including a rotor member, and a method for manufacturing a rotor member used in a rotary electric machine.

### BACKGROUND ART

As an invention related to a conventional rotor member, for example, a motor rotor described in Patent Document 1 is known. The motor rotor described in Patent Document 1 includes a soft magnetic yoke section and a magnet section. A material of the soft magnetic yoke section is soft magnetic powder containing a binder. A material of the magnet section is magnet powder containing a binder. The soft magnetic powder containing the binder and the magnet powder containing the binder are integrally molded.
Patent Document 1: Japanese Patent Application Laid-Open No. 2007-074888

### SUMMARY OF THE DISCLOSURE

By the way, there is a demand for improving adhesion strength between the soft magnetic yoke section and the magnet section in the motor rotor described in Patent Document 1.

Therefore, an object of the present disclosure is to provide a rotor member, a rotor, a rotary electric machine, a brushless motor, and a method for manufacturing a rotor member which enable improvement in fixing strength between a soft magnetic body and a hard magnetic body.

A rotor member according to an aspect of the present disclosure is a rotor member used in a rotary electric machine, the rotor member including: a soft magnetic body having a tubular shape and comprised of soft magnetic powder, the soft magnetic body having a first end surface facing a first direction along a central axis of the soft magnetic body and a second end surface facing a second direction opposite to the first direction; and a hard magnetic body having a tubular shape and comprised of hard magnetic powder, the hard magnetic body having a third end surface facing the first direction and a fourth end surface facing the second direction, the hard magnetic body being in contact with a peripheral surface of the soft magnetic body in a radial direction centered on the central axis, wherein a contact surface between the soft magnetic body and the hard magnetic body has a shape protruding in the radial direction entirely around the central axis such that a first position in the first direction at which a minimum width of a portion forming the contact surface in the soft magnetic body in the radial direction is different from a second position of the first end surface in the first direction, a third position of the second end surface in the first direction, a fourth position of the third end surface in the first direction, and a fifth position of the fourth end surface in the first direction.

A method for manufacturing a rotor member according to an aspect of the present disclosure includes: forming a preliminary hard magnetic body by compression-molding hard magnetic powder in which isotropic magnet powder and first binder powder are mixed; filling a die in such a manner that soft magnetic powder, in which iron powder and second binder powder are mixed, and the preliminary hard magnetic body are aligned in a radial direction centered on a central axis of the die and are in contact with each other after the forming of the preliminary hard magnetic body; and forming the rotor member by compression-molding the soft magnetic powder and the preliminary hard magnetic body from a first direction after the filling of the die, wherein a pressure for pressing the preliminary hard magnetic body is higher than a pressure for pressing the soft magnetic powder to form a rotor member having a soft magnetic body and a hard magnetic body in contact with each other.

According to the present disclosure, it is possible to provide the rotor member, the rotor, the rotary electric machine, the brushless motor, and the method for manufacturing a rotor member which enable the improvement in fixing strength between the soft magnetic body and the hard magnetic body.

### BRIEF EXPLANATION OF THE DRAWINGS

FIG. 1 is a perspective view of a rotor 10.

FIG. 2 is a sectional view of the rotor 10 taken along the line A-A.

FIG. 3 is a flowchart illustrating an example of a method for manufacturing the rotor member 1.

FIG. 4 is a sectional view which illustrates an example of a manufacturing step of the rotor member 1.

FIG. 5 is a sectional view which illustrates an example of a manufacturing step of the rotor member 1.

FIG. 6 is a sectional view which illustrates an example of a manufacturing step of the rotor member 1.

FIG. 7 is a sectional view which illustrates an example of a manufacturing step of the rotor member 1.

FIG. 8 is an external perspective view of a brushless motor 100 in which the rotor member 1 is used.

FIG. 9 is an exploded perspective view of the brushless motor 100 in which the rotor member 1 is used.

FIG. 10 is a sectional view of a rotor 20 according to a comparative example.

FIG. 11 is a model diagram of a shear test of the rotor member 1.

FIG. 12 is a model diagram of a shear test of a rotor member 6 according to a comparative example.

FIG. 13 shows results of the shear tests of the rotor member 1 and the rotor member 6 according to the comparative example.

FIG. 14 is a sectional view of a rotor 10a.

FIG. 15 is a sectional view of a rotor 10b.

FIG. 16 is a sectional view of a rotor 10c.

FIG. 17 is a sectional view of a rotor 10d.

FIG. 18 is a sectional view of a rotor 10e.

FIG. 19 is a sectional view of a rotor 10f.

### DETAILED DESCRIPTION OF THE PREFERRED EMBODIMENTS

### First Embodiment

### (Configuration of Rotor 10)

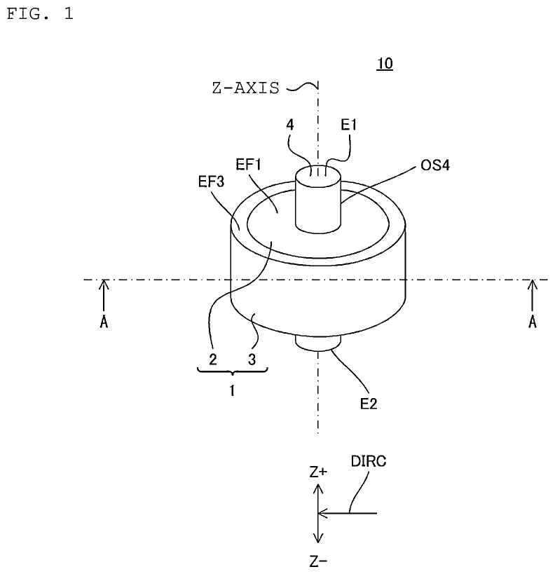

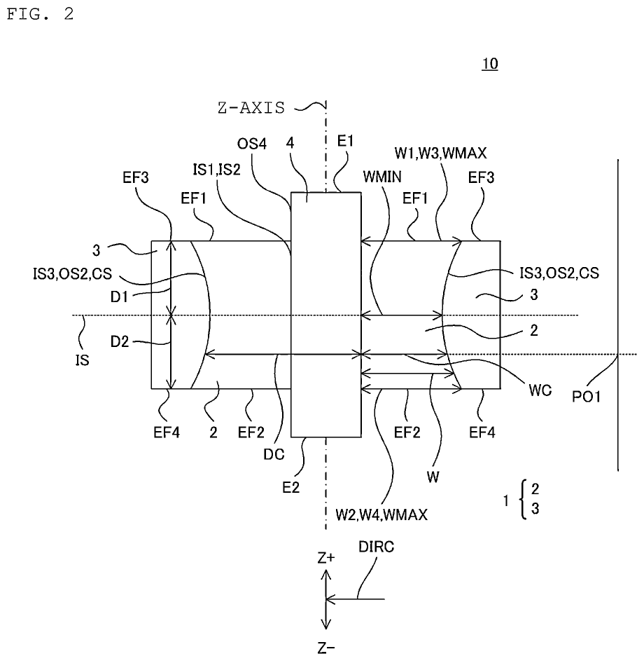

Hereinafter, a configuration of a rotor 10 according to a first embodiment of the present disclosure will be described with reference to the drawings. FIG. 1 is a perspective view of the rotor 10. FIG. 2 is a sectional view of the rotor 10 taken along the line A-A.

The rotor 10 is used for a brushless motor 100 to be described later. The brushless motor 100 is an example of a “rotary electric machine” of the present disclosure.

As illustrated in FIG. 1, the rotor 10 includes a shaft 4 and a rotor member 1. As illustrated in FIG. 1, the shaft 4 has a shape extending in a Z+ direction which is a positive direction of a Z-axis. More specifically, the shaft 4 has a columnar shape. A central axis of the shaft 4 is the Z-axis. In addition, the shaft 4 includes a first end E1 and a second end E2. The first end E1 is located in the Z+ direction with respect to an end of the rotor member 1 in the Z+ direction. The second end E2 is located in a Z− direction with respect to an end of the rotor member 1 in the Z− direction which is a negative direction of the Z-axis. The Z− direction is a direction opposite to the Z+ direction. In addition, the Z+ direction corresponds to a “first direction” of the present disclosure. The Z− direction corresponds to a “second direction” of the present disclosure. Each of the Z+ direction and the Z− direction is along the Z-axis.

As illustrated in FIG. 1, the rotor member 1 includes a soft magnetic body 2 and a hard magnetic body 3. The rotor member 1 has a cylindrical shape. A central axis of the rotor member 1 is the Z-axis. That is, the central axis of the rotor member 1 coincides with the central axis of the shaft 4. In addition, the rotor member 1 is disposed such that an inner edge of the rotor member 1 coincides with an outer edge of the shaft 4 as viewed in the Z− direction. That is, as illustrated in FIG. 2, an outer peripheral surface OS4 of the shaft 4 in a radial direction centered on the Z-axis is in contact with an inner peripheral surface IS1 of the rotor member 1 in the radial direction centered on the Z-axis.

As illustrated in FIG. 1, the soft magnetic body 2 has a cylindrical shape. A central axis of the soft magnetic body 2 is the Z-axis. That is, the central axis of the soft magnetic body 2 coincides with the central axis of the shaft 4. In addition, each of an inner edge of the soft magnetic body 2 and an outer edge of the soft magnetic body 2 viewed in the Z− direction has a circular shape. In addition, the soft magnetic body 2 is disposed such that the inner edge of the soft magnetic body 2 coincides with the outer edge of the shaft 4 as viewed in the Z− direction. That is, as illustrated in FIG. 2, the outer peripheral surface OS4 of the shaft 4 in the radial direction centered on the Z-axis is in contact with an inner peripheral surface IS2 of the soft magnetic body 2 in the radial direction centered on the Z-axis. Thus, the soft magnetic body 2 is in contact with the outer peripheral surface OS4 of the shaft 4 in the radial direction centered on the Z-axis.

As illustrated in FIG. 2, the soft magnetic body 2 has a first end surface EF1 and a second end surface EF2. More specifically, the first end surface EF1 is located at an end of the soft magnetic body 2 in the Z+ direction. In addition, the first end surface EF1 faces the Z+ direction. That is, a normal direction of the first end surface EF1 is the Z+ direction. The second end surface EF2 is located at an end of the soft magnetic body 2 in the Z− direction. In addition, the second end surface EF2 faces the Z− direction. That is, a normal direction of the second end surface EF2 is the Z− direction. In addition, each of an inner edge of the first end surface EF1 viewed in the Z− direction, an outer edge of the first end surface EF1 viewed in the Z− direction, an inner edge of the second end surface EF2 viewed in the Z+ direction, and an outer edge of the second end surface EF2 viewed in the Z+ direction has a circular shape.

The soft magnetic body 2 is a soft magnetic body. The soft magnetic body is magnetized when a magnetic field is applied from the outside. Thereafter, when the application of the magnetic field is stopped, the soft magnetic body loses its magnetization. A material of the soft magnetic body is, for example, iron.

The soft magnetic body 2 is a molded body formed of soft magnetic powder 21. The material of the soft magnetic powder 21 contains, for example, iron and a binder. Iron is an example of the soft magnetic body. The binder is, for example, resin. The soft magnetic powder 21 is, for example, a mixture of iron powder and epoxy resin powder as an example of binder powder. A method for forming the soft magnetic body 2 will be described later.

As illustrated in FIG. 1, the hard magnetic body 3 has a cylindrical shape. A central axis of the hard magnetic body 3 is the Z-axis. That is, the central axis of the hard magnetic body 3 coincides with the central axis of the shaft 4. In addition, each of an inner edge of the hard magnetic body 3 and an outer edge of the hard magnetic body 3 viewed in the Z− direction has a circular shape. In addition, the hard magnetic body 3 is disposed such that the inner edge of the hard magnetic body 3 coincides with the outer edge of the soft magnetic body 2 as viewed in the Z− direction. That is, as illustrated in FIG. 2, an inner peripheral surface IS3 of the hard magnetic body 3 in the radial direction centered on the Z-axis is in contact with an outer peripheral surface OS2 of the soft magnetic body 2 in the radial direction centered on the Z-axis. Thus, the hard magnetic body 3 is in contact with the outer peripheral surface OS2 of the soft magnetic body 2 in the radial direction centered on the Z-axis. In addition, as illustrated in FIGS. 1 and 2, the hard magnetic body 3 is not in contact with the inner peripheral surface IS2 of the soft magnetic body 2 in the radial direction centered on the Z-axis.

As illustrated in FIG. 2, the hard magnetic body 3 has a third end surface EF3 and a fourth end surface EF4. More specifically, the third end surface EF3 is located at an end of the hard magnetic body 3 in the Z+ direction. In addition, the third end surface EF3 faces the Z+ direction. That is, a normal direction of the third end surface EF3 is the Z+ direction. The fourth end surface EF4 is located at an end of the hard magnetic body 3 in the Z− direction. In addition, the fourth end surface EF4 faces the Z− direction. That is, a normal direction of the fourth end surface EF4 is the Z− direction. In addition, each of an inner edge of the third end surface EF3 viewed in the Z− direction, an outer edge of the third end surface EF3 viewed in the Z− direction, an inner edge of the fourth end surface EF4 viewed in the Z+ direction, and an outer edge of the fourth end surface EF4 viewed in the Z+ direction has a circular shape.

The hard magnetic body 3 is a hard magnetic body. The hard magnetic body is magnetized when a magnetic field is applied from the outside. Thereafter, the hard magnetic body does not lose its magnetization if the application of the magnetic field is stopped. A material of the hard magnetic body is a magnet.

The hard magnetic body 3 is a molded body formed of hard magnetic powder 31. The material of the hard magnetic powder 31 contains, for example, a magnet and a binder. The magnet is, for example, a rare earth magnet such as a neodymium magnet. The binder is, for example, resin. The hard magnetic powder 31 is, for example, a mixture of neodymium magnet powder and epoxy resin powder as an example of binder powder. A method for forming the hard magnetic body 3 will be described later.

As illustrated in FIG. 2, a position of the first end surface EF1 of the soft magnetic body 2 in the Z+ direction is equal to a position of the third end surface EF3 of the hard magnetic body 3 in the Z+ direction. In addition, a position of the second end surface EF2 of the soft magnetic body 2 in the Z+ direction is equal to a position of the fourth end surface EF4 of the hard magnetic body 3 in the Z+ direction.

The entire outer peripheral surface OS2 of the soft magnetic body 2 in the radial direction centered on the Z-axis is in surface contact with the entire inner peripheral surface IS3 of the hard magnetic body 3 in the radial direction centered on the Z-axis as illustrated in FIGS. 1 and 2. Therefore, each of the outer peripheral surface OS2 of the soft magnetic body 2 in the radial direction centered on the Z-axis and the inner peripheral surface IS3 of the hard magnetic body 3 in the radial direction centered on the Z-axis is defined as a contact surface CS between the soft magnetic body 2 and the hard magnetic body 3 in the present embodiment.

As illustrated in FIG. 2, the contact surface CS between the soft magnetic body 2 and the hard magnetic body 3 has a shape protruding in a centripetal direction DIRC in a case where the hard magnetic body 3 is in contact with the outer peripheral surface OS2 of the soft magnetic body 2. Here, the centripetal direction DIRC is a direction opposite to the radial direction centered on the Z-axis. Specifically, the centripetal direction DIRC is a direction orthogonal to the Z-axis and faces the Z-axis as viewed in the Z+ direction or the Z− direction. In other words, the centripetal direction DIRC is a direction facing the Z-axis as viewed in the Z+ direction or the Z− direction. In the present embodiment, the contact surface CS between the soft magnetic body 2 and the hard magnetic body 3 has a shape that is curved to protrude in the centripetal direction DIRC as illustrated in FIG. 2. In addition, the contact surface CS between the soft magnetic body 2 and the hard magnetic body 3 is a curved surface and does not include a flat surface.

Since the contact surface CS between the soft magnetic body 2 and the hard magnetic body 3 has the shape protruding in the centripetal direction DIRC in this manner, a position of the contact surface CS between the soft magnetic body 2 and the hard magnetic body 3 in the centripetal direction DIRC is non-uniform in the Z+ direction as illustrated in FIG. 2. That is, a width W of a portion (the outer peripheral surface OS2) forming the contact surface CS in the soft magnetic body 2 in the radial direction centered on the Z-axis is non-uniform in the Z+ direction.

In other words, the width W of the portion forming the contact surface CS in the soft magnetic body 2 in the radial direction centered on the Z-axis is a distance (for example, a distance WC in FIG. 2) between the inner peripheral surface IS2 and the outer peripheral surface OS2 in the centripetal direction DIRC at a first position PO1 in a case where there is no member (for example, the shaft 4 in FIG. 2), space, or the like other than the soft magnetic body 2 between the inner peripheral surface IS2 and the outer peripheral surface OS2 at the first position PO1 out of distances (for example, the distances WC and DC in FIG. 2) between the inner peripheral surface IS2 and the outer peripheral surface OS2 in the centripetal direction DIRC at a position (for example, the first position PO1 in FIG. 2) in the Z+ direction where the soft magnetic body 2 exists.

A position in the Z+ direction at which the width W is a minimum width WMIN is a position different from any of the position of the first end surface EF1 in the Z+ direction, the position of the second end surface EF2 in the Z+ direction, the position of the third end surface EF3 in the Z+ direction, and the position of the fourth end surface EF4 in the Z+ direction. In the present embodiment, there is only one position in the Z+ direction at which the width W is minimized as illustrated in FIG. 2, and is equal to a position of an intermediate surface IS in the Z+ direction. That is, the position in the Z+ direction at which the width W is minimized is only the position of the intermediate surface IS in the Z+ direction. Here, the intermediate surface IS is a surface where a distance D1 from the third end surface EF3 of the hard magnetic body 3 in the Z+ direction is equal to a distance D2 from the fourth end surface EF4 of the hard magnetic body 3. Such an intermediate surface IS is a plane perpendicular to the Z-axis since the normal direction of the third end surface EF3 is the Z+ direction and the normal direction of the fourth end surface EF4 is the Z− direction.

In addition, the soft magnetic body 2 has the following configuration in the present embodiment. The width W (hereinafter referred to as a “width W1”) at the position of the first end surface EF1 in the Z+ direction is equal to the width W (hereinafter referred to as a “width W2”) at the position of the second end surface EF2 in the Z+ direction, and is a maximum width WMAX of the portion forming the contact surface CS in the soft magnetic body 2 (W1=W2=WMAX). The position of the third end surface EF3 in the Z+ direction is equal to the position of the first end surface EF1 in the Z+ direction in the present embodiment. Therefore, the width W (hereinafter referred to as a “width W3”) at the position of the third end surface EF3 in the Z+ direction is equal to the width W1 (W3=W1). In addition, the position of the fourth end surface EF4 in the Z+ direction is equal to the position of the second end surface EF2 in the Z+ direction. Therefore, the width W (hereinafter referred to as a “width W4”) at the position of the fourth end surface EF4 in the Z+ direction is equal to the width W2 (W4=W2).

### (Method for Manufacturing Rotor Member 1)

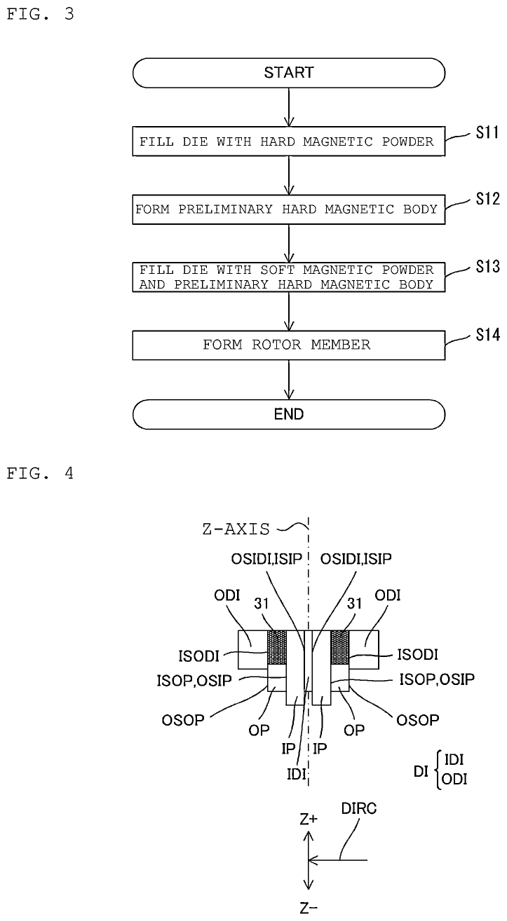

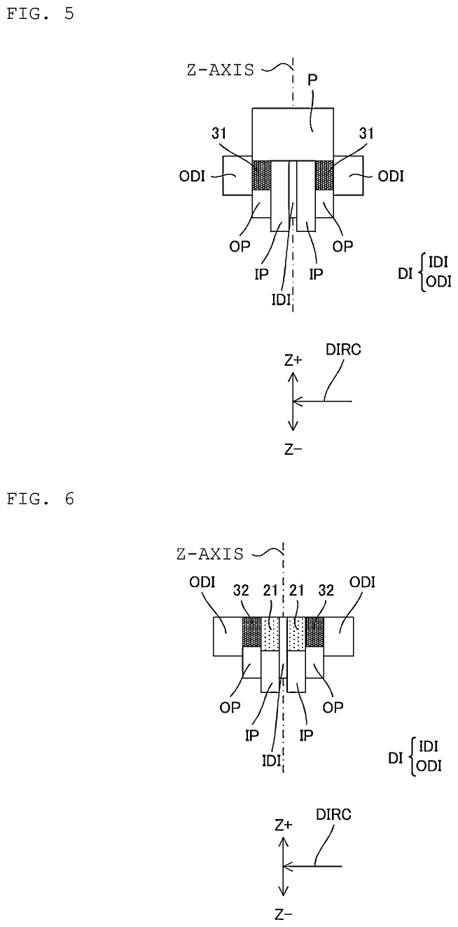

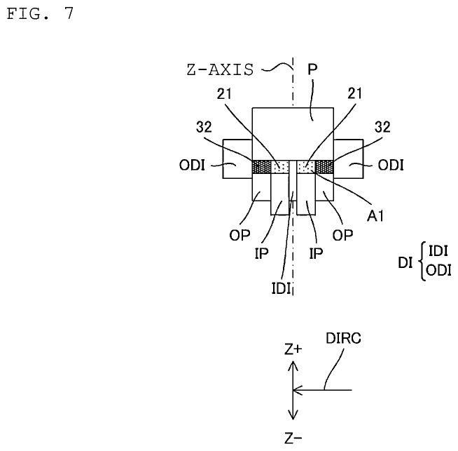

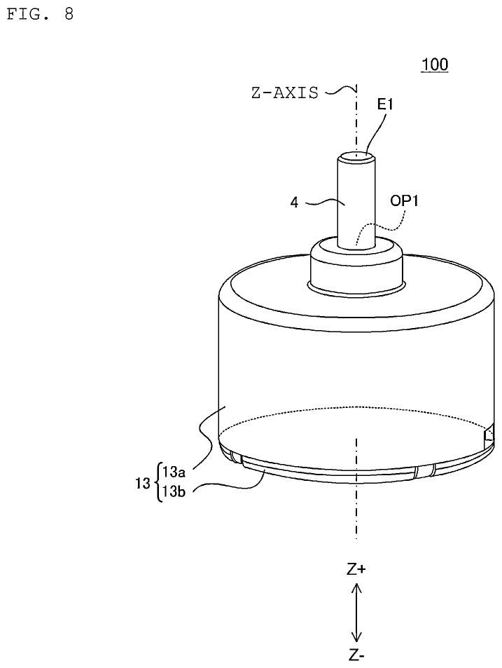

Next, an example of a method for manufacturing the rotor member 1 will be described with reference to the drawings. FIG. 3 is a flowchart illustrating an example of the method for manufacturing the rotor member 1. FIG. 4 is a sectional view which illustrates an example of a manufacturing step of the rotor member 1. FIG. 5 is a sectional view which illustrates an example of a manufacturing step of the rotor member 1. FIG. 6 is a sectional view which illustrates an example of a manufacturing step of the rotor member 1. FIG. 7 is a sectional view which illustrates an example of a manufacturing step of the rotor member 1.

First, the hard magnetic powder 31 is applied to fill a gap between an inner punch IP and an outer die ODI, which is a portion of a die DI, in the Z+ direction with respect to an outer punch OP (FIG. 3: step S11). More specifically, the hard magnetic powder 31 is, for example, a mixture of neodymium magnet powder and epoxy resin powder. The neodymium magnet powder is an example of each of “rare earth magnet powder” and “isotropic magnet powder” of the present disclosure. The epoxy resin powder is an example of each of “resin” and “first binder powder” of the present disclosure.

Each of the inner punch IP, the outer punch OP, and the outer die ODI has a cylindrical shape. A central axis of each of the inner punch IP, the outer punch OP, and the outer die ODI is the Z-axis. As illustrated in FIG. 4, the outer punch OP is disposed in the centripetal direction DIRC with respect to the outer die ODI. In addition, the inner punch IP is disposed in the centripetal direction DIRC with respect to the outer punch OP. In addition, an outer peripheral surface OSOP of the outer punch OP in the radial direction centered on the Z-axis is in contact with an inner peripheral surface ISODI of the outer die ODI in the radial direction centered on the Z-axis. In addition, an outer peripheral surface OSIP of the inner punch IP in the radial direction centered on the Z-axis is in contact with an inner peripheral surface ISOP of the outer punch OP in the radial direction centered on the Z-axis. The inner punch IP and the outer punch OP are movable in the Z+ direction and the Z− direction, respectively.

The die DI includes the outer die ODI and the inner die IDI described above. The inner die IDI has a columnar shape. A central axis of the inner die IDI is the Z-axis. As illustrated in FIG. 4, the inner die IDI is disposed in the centripetal direction DIRC with respect to the inner punch IP. In addition, an outer peripheral surface OSIDI of the inner die IDI in the radial direction centered on the Z-axis is in contact with an inner peripheral surface ISIP of the inner punch IP in the radial direction centered on the Z-axis.

As illustrated in FIG. 5, the applied hard magnetic powder 31 is pressed in the Z− direction by the outer punch OP disposed in the Z− direction with respect to the hard magnetic powder 31 and a punch P disposed in the Z+ direction with respect to the hard magnetic powder 31. An end surface of the punch P in the Z− direction faces the Z− direction. That is, a normal direction of the end surface of the punch P in the Z− direction is the Z− direction.

A pressure for pressing the hard magnetic powder 31 is, for example, 300 MPa. Thus, the hard magnetic powder 31 is compression-molded to form a preliminary hard magnetic body 32 (FIG. 3: step S12, a preliminary hard magnetic body formation step). More specifically, a thickness of the preliminary hard magnetic body 32 in the radial direction centered on the Z-axis is uniform in the Z+ direction.

After the preliminary hard magnetic body formation step, the soft magnetic powder 21 and the preliminary hard magnetic body 32 are applied to fill the die DI so as to be aligned in the radial direction centered on the Z-axis and be in contact with each other as illustrated in FIG. 6 (FIG. 3: step S13, a filling step). More specifically, the soft magnetic powder 21 is, for example, a mixture of iron powder and epoxy resin powder. The epoxy resin powder is an example of each of the “resin” and “second binder powder” of the present disclosure.

After the filling step, as illustrated in FIG. 7, the applied soft magnetic powder 21 and preliminary hard magnetic body 32 are pressed in the Z− direction by the inner punch IP and the outer punch OP disposed in the Z− direction with respect to the soft magnetic powder 21 and the preliminary hard magnetic body 32, respectively, and by the punch P disposed in the Z+ direction with respect to each of the soft magnetic powder 21 and the preliminary hard magnetic body 32. Here, a pressure for pressing the preliminary hard magnetic body 32 is higher than a pressure for pressing the soft magnetic powder 21. The pressure for pressing the preliminary hard magnetic body 32 is, for example, 800 MPa. Thus, the soft magnetic powder 21 and the preliminary hard magnetic body 32 are compression-molded from the Z+ direction to form a main molded body. The formed main molded body is thermally cured to form the rotor member 1 (FIG. 3: step S14, a rotor member formation step).

When the main molded body is formed, a position in the Z+ direction of an end surface of the inner punch IP in the Z+ direction is equal to a position in the Z+ direction of an end surface of the outer punch OP in the Z+ direction. Thus, the position in the Z+ direction of the second end surface EF2 of the soft magnetic body 2 can be made equal to the position in the Z+ direction of the fourth end surface EF4 of the hard magnetic body 3. In a case where the die DI is bent, the position in the Z+ direction of the second end surface EF2 of the soft magnetic body 2 can be made equal to the position in the Z+ direction of the fourth end surface EF4 of the hard magnetic body 3 by adjusting the position in the Z+ direction of the end surface of the inner punch IP in the Z+ direction and the position in the Z+ direction of the end surface of the outer punch OP in the Z+ direction. In addition, since the soft magnetic powder 21 and the preliminary hard magnetic body 32 are integrally molded in the Z− direction by the punch P whose end surface in the Z− direction faces the Z− direction, the position in the Z+ direction of the first end surface EF1 of the soft magnetic body 2 can be made equal to the position in the Z+ direction of the third end surface EF3 of the hard magnetic body 3.

In addition, the pressure required for forming the hard magnetic body 3 is higher than the pressure required for forming the soft magnetic body 2. Thus, the contact surface CS between the soft magnetic body 2 and the hard magnetic body 3 can be formed into a shape protruding in the centripetal direction DIRC by controlling pressure conditions (average pressure, pressure distribution, pressing time, and the like) for pressing each of the soft magnetic powder 21 and the preliminary hard magnetic body 32. More specifically, it is possible to make the hard magnetic body 3 enter in the centripetal direction DIRC (for example, a region A1 in FIG. 2) while forming the soft magnetic body 2 by providing a period in which the pressure for pressing each of the soft magnetic powder 21 and the preliminary hard magnetic body 32 is set to be higher than the pressure required for forming the soft magnetic body 2 and lower than the pressure required for forming the hard magnetic body 3 when the soft magnetic powder 21 and the preliminary hard magnetic body 32 are pressed from the Z− direction by the inner punch IP and the outer punch OP, respectively, and from the Z+ direction by the punch P. Therefore, the contact surface CS between the soft magnetic body 2 and the hard magnetic body 3 can be formed into the shape protruding in the centripetal direction DIRC.

### (Configuration of Brushless Motor 100)

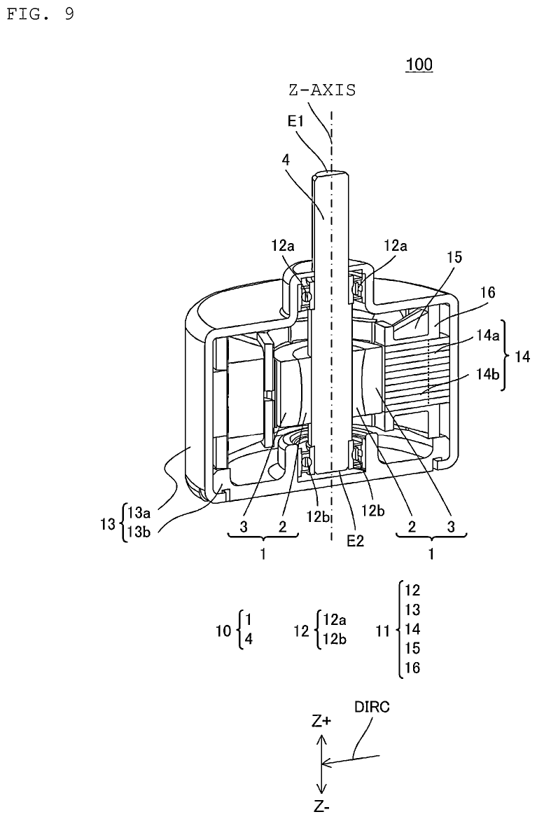

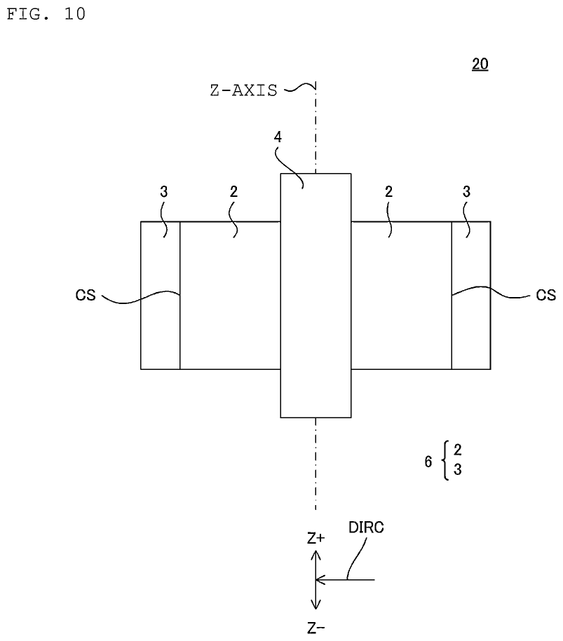

Hereinafter, a configuration of the brushless motor 100 according to the first embodiment of the present disclosure will be described with reference to the drawings. FIG. 8 is an external perspective view of the brushless motor 100 in which the rotor member 1 is used. FIG. 9 is an exploded perspective view of the brushless motor 100 in which the rotor member 1 is used. In FIG. 9, among a plurality of tooth portions 14b, a plurality of coils 15, and a plurality of insulating members 16, only the representative tooth portion 14b, coil 15, and insulating member 16 are denoted by reference symbols, respectively.

As illustrated in FIGS. 8 and 9, the brushless motor 100 includes a stator assembly 11, the shaft 4, and the rotor member 1. As illustrated in FIG. 9, the stator assembly 11 is disposed around the rotor 10 as viewed in the Z− direction. That is, the brushless motor 100 is an inner rotor type.

As illustrated in FIG. 9, the stator assembly 11 includes a bearing 12, a housing 13, a magnetic core 14, the plurality of coils 15, and the plurality of insulating members 16.

The bearing 12 supports the shaft 4 such that the shaft 4 can rotate in a circumferential direction centered on the Z-axis. More specifically, the bearing 12 includes a first bearing 12a and a second bearing 12b as illustrated in FIG. 9. Each of the first bearing 12a and the second bearing 12b has a cylindrical shape. A central axis of each of the first bearing 12a and the second bearing 12b is the Z-axis. The central axis of each of the first bearing 12a and the second bearing 12b coincides with the central axis of the shaft 4.

The first bearing 12a is located in the Z+ direction with respect to the second bearing 12b as illustrated in FIG. 9. In addition, the first bearing 12a is located in the Z+ direction with respect to the rotor member 1. The second bearing 12b is located in the Z− direction with respect to the rotor member 1. The second bearing 12b supports the second end E2 of the shaft 4.

As illustrated in FIG. 8, the housing 13 includes a first housing 13a and a second housing 13b. As illustrated in FIGS. 8 and 9, the first housing 13a has a cylindrical shape. A central axis of the first housing 13a is the Z-axis. The second housing 13b is located in the Z− direction with respect to the first housing 13a. In addition, the first housing 13a has an opening OP1. Thus, the first end E1 of the shaft 4 protrudes from the opening OP1 in the Z+ direction. That is, the brushless motor 100 is a single-shaft type.

The first housing 13a supports the first bearing 12a, the magnetic core 14, the plurality of coils 15, and the plurality of insulating members 16. The second housing 13b supports the second bearing 12b. A material of each of the first housing 13a and the second housing 13b is, for example, a material having high rigidity such as SUS.

The magnetic core 14 is a soft magnetic body. The magnetic core 14 is manufactured by laminating electromagnetic steel sheets as illustrated in FIG. 9. The magnetic core 14 includes a core back portion 14a having a cylindrical shape and the plurality of tooth portions 14b. A central axis of the core back portion 14a is the Z-axis. The number of the tooth portions 14b is nine. The nine tooth portions 14b are disposed in the circumferential direction centered on the Z-axis. In addition, each of the nine tooth portions 14b extends from an inner side surface of the core back portion 14a in a direction opposite to the radial direction centered on the Z-axis. The outer surface of the magnetic core 14 is subjected to insulation processing. The magnetic core 14 is magnetized by each of a magnetic field generated by the hard magnetic body 3 and a magnetic field generated by the coil 15 to be described later.

Each of the number of the plurality of coils 15 and the number of the plurality of insulating members 16 is nine. The respective nine coils 15 and the respective nine insulating members 16 are provided to correspond to the respective nine tooth portions 14b. More specifically, assuming that a group including one tooth portion 14b, one coil 15, and one insulating member 16 is one set, nine sets are aligned in the circumferential direction centered on the Z-axis. The respective sets are disposed around the hard magnetic body 3 with a clearance from the hard magnetic body 3. The respective sets have the same structure. Therefore, one set including one tooth portion 14b, one coil 15, and one insulating member 16 will be described.

As illustrated in FIG. 9, the coil 15 is wound around the tooth portion 14b so as to be located around the tooth portion 14b as viewed in the radial direction centered on the Z-axis. The coil 15 is made of, for example, a conductive material such as copper. In addition, the coil 15 has a structure in which the surface of a copper wire is covered with an insulating film. The coil 15 generates the magnetic field when a current flows through the coil 15.

The insulating member 16 is an insulator. The insulating member 16 is disposed between the magnetic core 14 and the coil 15 as illustrated in FIG. 9. Thus, the magnetic core 14 and the coil 15 are electrically insulated.

The current is supplied from a power supply (not illustrated) to the coil 15. The rotation of the rotor 10 is controlled by controlling the current.

### [Effects]

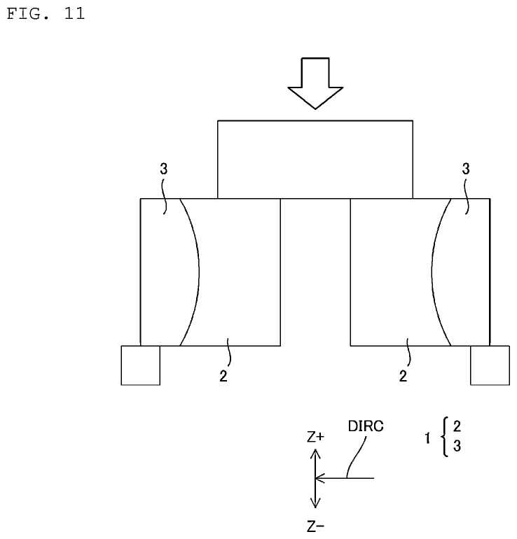

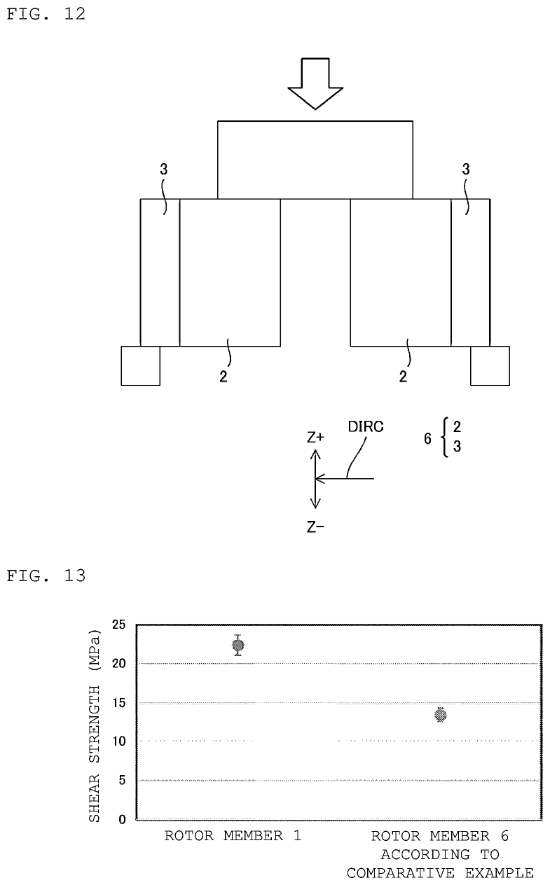

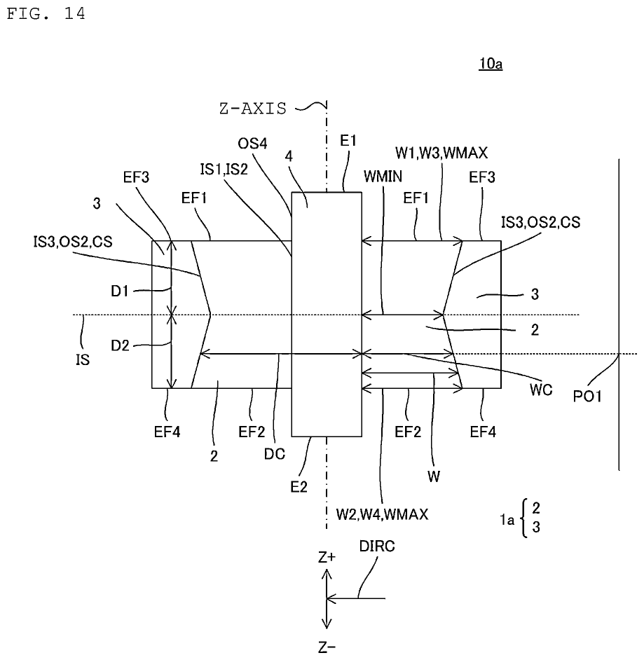

The inventor of the present application conducted a shear test for each of the rotor member 1 and a rotor member 6 according to a comparative example in order to confirm improvement in fixing strength between the soft magnetic body 2 and the hard magnetic body 3. The shear test of each of the rotor member 1 and the rotor member 6 according to the comparative example will be described with reference to the drawings. FIG. 10 is a sectional view of a rotor 20 according to the comparative example. FIG. 11 is a model diagram of the shear test of the rotor member 1. FIG. 12 is a model diagram of the shear test of the rotor member 6 according to the comparative example. FIG. 13 illustrates results of the shear tests of the rotor member 1 and the rotor member 6 according to the comparative example.

First, the rotor 20 according to the comparative example will be described. Regarding the rotor 20 according to the comparative example, only a portion different from the rotor 10 will be described, and the other portions will not be described. In the rotor 20 according to the comparative example, a position of the contact surface CS between the soft magnetic body 2 and the hard magnetic body 3 in the centripetal direction DIRC is uniform in the Z+ direction as illustrated in FIG. 10. Therefore, in the rotor 20 according to the comparative example, the contact surface CS between the soft magnetic body 2 and the hard magnetic body 3 does not have the shape protruding in the centripetal direction DIRC.

Next, the shear test of each of the rotor member 1 and the rotor member 6 according to the comparative example will be described. Here, when a current flows through the coil 15, a rotational torque is generated in each of the rotor 10 and the rotor 20 according to the comparative example. At this time, stress in a tangential direction is applied to each of the rotor 10 and the rotor 20 according to the comparative example with respect to a rotation direction (the circumferential direction centered on the Z-axis) of each of the rotor 10 and the rotor 20 according to the comparative example. Shear stress is mainly applied to the contact surface CS between the soft magnetic body 2 and the hard magnetic body 3. Although tensile stress is also applied to the contact surface CS between the soft magnetic body 2 and the hard magnetic body 3 as a rotation speed of each of the rotor 10 and the rotor 20 according to the comparative example increases, it is assumed that large shear stress is applied to the contact surface CS between the soft magnetic body 2 and the hard magnetic body 3 in many cases when the rotor member 1 according to the present disclosure is used as the rotor 10 of the rotary electric machine. Therefore, shear strength of the contact surface CS between the soft magnetic body 2 and the hard magnetic body 3 was used as an index for the fixing strength between the soft magnetic body 2 and the hard magnetic body 3.

As illustrated in FIGS. 10 and 11, a force was applied in the Z− direction to each of the rotor member 1 and the rotor member 6 according to the comparative example in the shear test of each of the rotor member 1 and the rotor member 6 according to the comparative example.

As illustrated in FIG. 13, shear strength of the contact surface CS between the soft magnetic body 2 and the hard magnetic body 3 in the rotor member 1 is larger than shear strength of the contact surface CS between the soft magnetic body 2 and the hard magnetic body 3 in the rotor member 6 according to the comparative example. More specifically, the shear strength of the contact surface CS between the soft magnetic body 2 and the hard magnetic body 3 in the rotor member 6 according to the comparative example is equal to or less than 20 MPa, which is practically required as the rotor 10 of the rotary electric machine, whereas the shear strength of the contact surface CS between the soft magnetic body 2 and the hard magnetic body 3 in the rotor member 1 is equal to or more than 20 MPa. In this manner, the shear strength of the contact surface CS between the soft magnetic body 2 and the hard magnetic body 3 can be improved according to the rotor member 1. As a result, the fixing strength between the soft magnetic body 2 and the hard magnetic body 3 can be improved according to the rotor member 1.

The fixing strength between the soft magnetic body 2 and the hard magnetic body 3 can be further improved according to the rotor member 1. More specifically, the contact surface CS between the soft magnetic body 2 and the hard magnetic body 3 in the rotor member 1 has the shape that is curved to protrude in the centripetal direction DIRC. Therefore, the area of the contact surface CS between the soft magnetic body 2 and the hard magnetic body 3 can be increased. As a result, the fixing strength between the soft magnetic body 2 and the hard magnetic body 3 can be further improved according to the rotor member 1.

According to the rotor member 1, desired magnetic characteristics are easily obtained with fewer soft magnetic bodies. More specifically, the position in the Z+ direction at which the width W of the portion forming the contact surface CS in the radial direction centered on the Z-axis is minimized is equal to a position in the Z+ direction of the intermediate surface IS. Here, the intermediate surface IS is a surface where a distance D1 from the third end surface EF3 of the hard magnetic body 3 in the Z+ direction is equal to a distance D2 from the fourth end surface EF4 of the hard magnetic body 3. Thus, a position in the Z+ direction at which a width of the hard magnetic body 3 in the radial direction centered on the Z-axis is maximized is easily made equal to the position in the Z+ direction of the intermediate surface IS. Therefore, it is easy to suppress leakage magnetic flux out of magnetic flux generated by the hard magnetic body 3. As a result, desired magnetic characteristics are easily obtained with fewer soft magnetic bodies according to the rotor member 1.

According to the rotor member 1, desired magnetic characteristics are easily obtained with fewer soft magnetic bodies. More specifically, it is sufficient that there is one position in the Z+ direction at which a permeance value for the magnetic flux generated by the hard magnetic body 3 is maximized. Therefore, there is only one position in the Z+ direction at which the width W of the portion forming the contact surface CS in the radial direction centered on the Z-axis is minimized. Therefore, the soft magnetic body can be effectively utilized according to the rotor member 1. As a result, desired magnetic characteristics are easily obtained with fewer soft magnetic bodies according to the rotor member 1.

According to the rotor member 1, desired magnetic characteristics are easily obtained with fewer soft magnetic bodies. More specifically, the distribution of the permeance value for the magnetic flux generated by the hard magnetic body 3 with respect to the position in the Z+ direction is continuous. Therefore, the contact surface CS is a curved surface and does not include a flat surface. Therefore, according to the rotor member 1, the shape of the soft magnetic body 2 is continuously changed in accordance with a change in the permeance value for the magnetic flux generated by the hard magnetic body 3 with respect to the position in the Z+ direction, so that the soft magnetic body can be effectively utilized. As a result, desired magnetic characteristics are easily obtained with fewer soft magnetic bodies according to the rotor member 1.

The rotor member 1 can be manufactured by the method for manufacturing the rotor member 1 according to the first embodiment of the present disclosure. More specifically, in the preliminary hard magnetic body formation step, the hard magnetic powder 31 in which the isotropic magnet powder and the first binder powder are mixed is compression-molded to form the preliminary hard magnetic body 32. In the filling step after the preliminary hard magnetic body formation step, the soft magnetic powder 21, in which the iron powder and the second binder powder are mixed, and the preliminary hard magnetic body 32 are applied to fill the die DI so as to be aligned in the radial direction centered on the Z-axis and be in contact with each other. In the rotor member formation step after the filling step, the soft magnetic powder 21 and the preliminary hard magnetic body 32 are compression-molded from the Z+ direction to form the rotor member 1. Here, in the rotor member formation step, the pressure for pressing the preliminary hard magnetic body 32 is higher than the pressure for pressing the soft magnetic powder 21. Thus, the main molded body is formed. As a result, the rotor member 1 can be manufactured by the method for manufacturing the rotor member 1 according to the first embodiment of the present disclosure.

With the method for manufacturing the rotor member 1 according to the first embodiment of the present disclosure, the rotor member 1 can be easily manufactured. More specifically, the pressure required for forming the soft magnetic body 2 is lower than the pressure required for forming the hard magnetic body 3. Therefore, the period in which the pressure for pressing each of the soft magnetic powder 21 and the preliminary hard magnetic body 32 is set to be higher than the pressure required for forming the soft magnetic body 2 and lower than the pressure required for forming the hard magnetic body 3 is provided when each of the soft magnetic powder 21 and the preliminary hard magnetic body 32 is pressed from the Z+ direction. Thus, it is possible to make the hard magnetic body 3 enter in the centripetal direction DIRC while forming the soft magnetic body 2. Therefore, the contact surface CS between the soft magnetic body 2 and the hard magnetic body 3 can be formed into the shape protruding in the centripetal direction DIRC. As a result, the rotor member 1 can be easily manufactured by the method for manufacturing the rotor member 1 according to the first embodiment of the present disclosure.

### [First Modification]

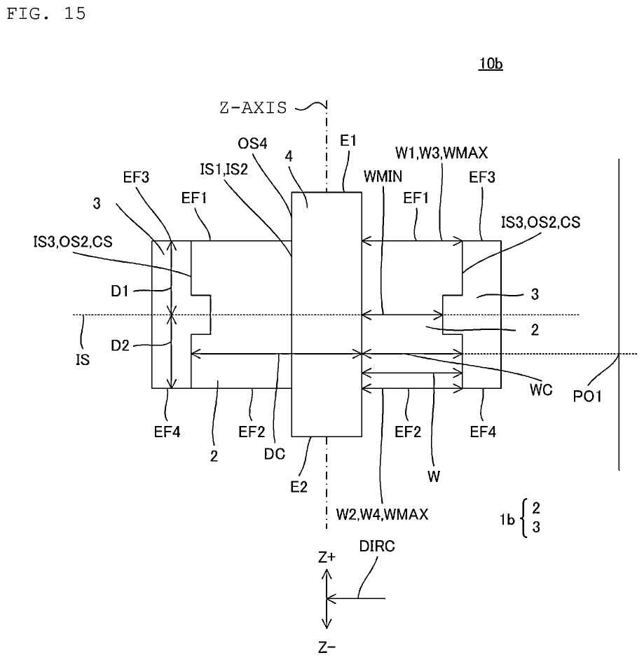

Hereinafter, a rotor member 1a according to a first modification of the present disclosure will be described with reference to the drawings. FIG. 14 is a sectional view of a rotor 10a. Regarding the rotor member 1a according to the first modification, only a portion different from those of the rotor member 1 according to the first embodiment will be described, and the other portions will not be described.

As illustrated in FIG. 14, the rotor member 1a is different from the rotor member 1 in that the contact surface CS between the soft magnetic body 2 and the hard magnetic body 3 has a shape that is bent so as to protrude in the centripetal direction DIRC.

The rotor member 1a as described above also has the same effects as the rotor member 1. In addition, fixing strength between the soft magnetic body 2 and the hard magnetic body 3 can be further improved according to the rotor member 1a. More specifically, the contact surface CS between the soft magnetic body 2 and the hard magnetic body 3 in the rotor member 1 has the shape that is bent to protrude in the centripetal direction DIRC. Therefore, the area of the contact surface CS between the soft magnetic body 2 and the hard magnetic body 3 can be increased. As a result, the fixing strength between the soft magnetic body 2 and the hard magnetic body 3 can be further improved according to the rotor member 1a.

### [Second Modification]

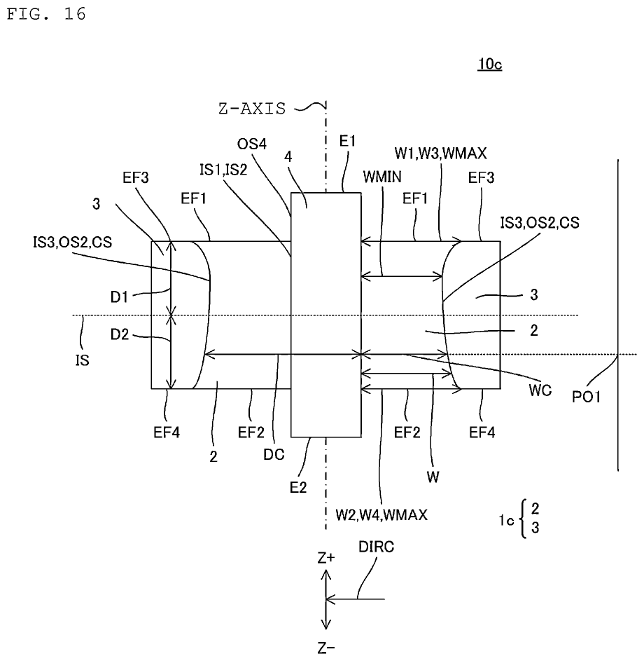

Hereinafter, a rotor member 1b according to a second modification of the present disclosure will be described with reference to the drawings. FIG. 15 is a sectional view of the rotor 10b. Regarding the rotor member 1b according to the second modification, only a portion different from those of the rotor member 1a according to the first modification will be described, and the other portions will not be described.

As illustrated in FIG. 15, the rotor member 1b is different from the rotor member 1a in that a position in the Z+ direction at which the width W of a portion forming the contact surface CS in the soft magnetic body 2 in the radial direction centered on the Z-axis is the minimum width WMIN is not only a position in the Z+ direction of the intermediate surface IS. In addition, the contact surface CS between the soft magnetic body 2 and the hard magnetic body 3 includes a flat surface.

The rotor member 1b as described above also has the same effects as the rotor member 1a.

### [Third Modification]

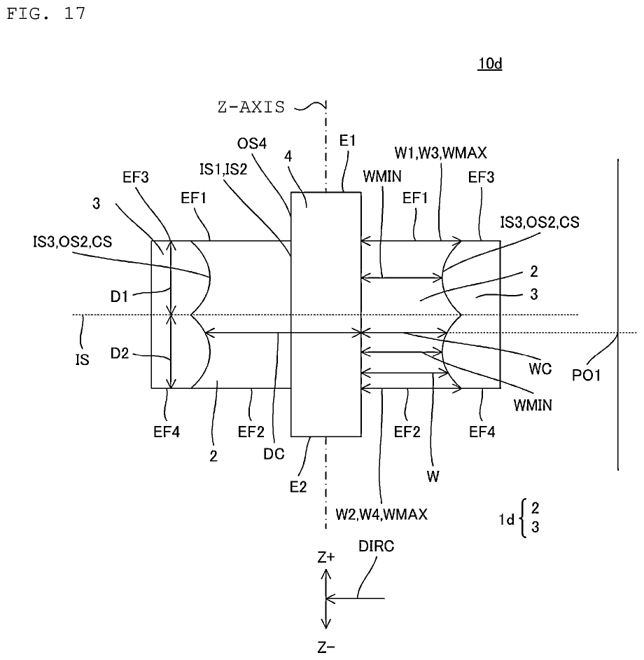

Hereinafter, a rotor member 1c according to a third modification of the present disclosure will be described with reference to the drawings. FIG. 16 is a sectional view of a rotor 10c. Regarding the rotor member 1c according to the third modification, only a portion different from those of the rotor member 1 according to the first embodiment will be described, and the other portions will not be described.

As illustrated in FIG. 16, the rotor member 1c is different from the rotor member 1 in that a position in the Z+ direction at which the width W of a portion forming the contact surface CS in the soft magnetic body 2 in the radial direction centered on the Z-axis is the minimum width WMIN is different from a position in the Z+ direction of the intermediate surface IS.

In the present modification, the position in the Z+ direction at which the width W of the portion forming the contact surface CS in the soft magnetic body 2 in the radial direction centered on the Z-axis is the minimum width WMIN is in the Z+ direction with respect to the position in the Z+ direction of the intermediate surface IS as illustrated in FIG. 16.

The rotor member 1c as described above also has the same effects as the rotor member 1. In addition, desired magnetic characteristics are easily obtained according to the rotor member 1c. More specifically, the position in the Z+ direction at which the width W of the portion forming the contact surface CS in the radial direction centered on the Z-axis is minimized is different from the position in the Z+ direction of the intermediate surface IS. Therefore, in a case where the magnetic core 14 has an asymmetric shape, a magnetic circuit formed by the soft magnetic body 2 can be flexibly designed. As a result, desired magnetic characteristics are easily obtained according to the rotor member 1c.

### [Fourth Modification]

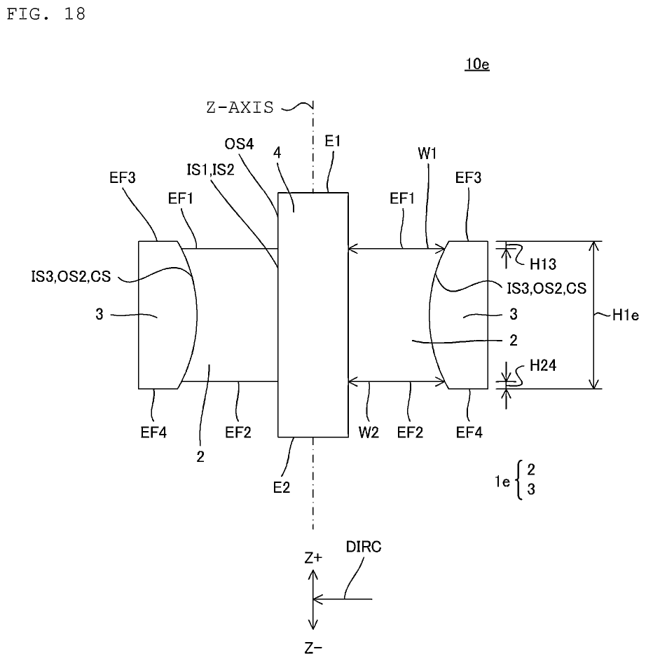

Hereinafter, a rotor member 1d according to a fourth modification of the present disclosure will be described with reference to the drawings. FIG. 17 is a sectional view of a rotor 10d. Regarding the rotor member 1d according to the fourth modification, only a portion different from those of the rotor member 1 according to the first embodiment will be described, and the other portions will not be described.

As illustrated in FIG. 17, the rotor member 1d is different from the rotor member 1 in that there are two positions in the Z+ direction at which the width W of a portion forming the contact surface CS in the soft magnetic body 2 in the radial direction centered on the Z-axis is the minimum width WMIN.

Specifically, the position in the Z+ direction at which the width W of the portion forming the contact surface CS in the soft magnetic body 2 in the radial direction centered on the Z-axis is the minimum width WMIN exists in each of the Z+ direction and the Z− direction with respect to a position in the Z+ direction of the intermediate surface IS as illustrated in FIG. 17.

The rotor member 1d as described above also has the same effects as the rotor member 1. In addition, fixing strength between the soft magnetic body 2 and the hard magnetic body 3 can be further improved according to the rotor member 1d. More specifically, there are a plurality of positions in the Z+ direction at which the width W of the portion forming the contact surface CS in the radial direction centered on the Z-axis is minimized. Therefore, the area of the contact surface CS between the soft magnetic body 2 and the hard magnetic body 3 can be increased. As a result, the fixing strength between the soft magnetic body 2 and the hard magnetic body 3 can be further improved according to the rotor member 1d.

### [Fifth Modification]

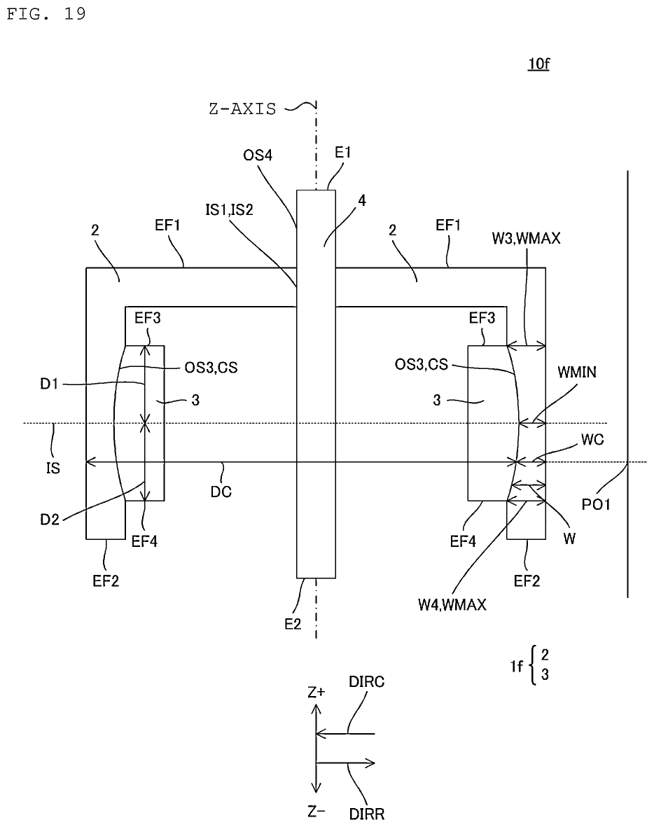

Hereinafter, a rotor member 1e according to a fifth modification of the present disclosure will be described with reference to the drawings. FIG. 18 is a sectional view of a rotor 10e. Regarding the rotor member 1e according to the fifth modification, only a portion different from those of the rotor member 1 according to the first embodiment will be described, and the other portions will not be described.

As illustrated in FIG. 18, the rotor member 1e is different from the rotor member 1 in that a position of the first end surface EF1 of the soft magnetic body 2 in the Z+ direction is different from a position of the third end surface EF3 of the hard magnetic body 3 in the Z+ direction, and a position of the second end surface EF2 of the soft magnetic body 2 in the Z+ direction is different from a position of the fourth end surface EF4 of the hard magnetic body 3 in the Z+ direction.

In addition, the first end surface EF1 is located in the Z− direction with respect to the third end surface EF3 as illustrated in FIG. 18 in the present modification. Therefore, the width W3 does not exist. A distance H13 between the first end surface EF1 and the third end surface EF3 in the Z+ direction is larger than zero. In addition, the distance H13 between the first end surface EF1 and the third end surface EF3 in the Z+ direction is 5% or less of a length H1e of the rotor member 1e in the Z+ direction.

More specifically, the second end surface EF2 is located in the Z+ direction with respect to the fourth end surface EF4 as illustrated in FIG. 18 in the present modification. Therefore, the width W4 does not exist. A distance H24 between the second end surface EF2 and the fourth end surface EF4 in the Z+ direction is larger than zero. In addition, the distance H24 between the second end surface EF2 and the fourth end surface EF4 in the Z+ direction is 5% or less of the length H1e of the rotor member 1e in the Z+ direction.

The rotor member 1e as described above also has the same effects as the rotor member 1. In addition, it is possible to suppress the occurrence of a tear or a crack in the hard magnetic body 3 according to the rotor member 1e. More specifically, in a case where the die DI is bent, the position of the first end surface EF1 in the Z+ direction is different from the position of the third end surface EF3 in the Z+ direction. In addition, the position of the second end surface EF2 in the Z+ direction is different from the position of the fourth end surface EF4 in the Z+ direction. When the distance H13 between the first end surface EF1 and the third end surface EF3 in the Z+ direction is large or the distance H24 between the second end surface EF2 and the fourth end surface EF4 in the Z+ direction is large, the hard magnetic body 3 is likely to be torn or cracked. Therefore, the distance H13 between the first end surface EF1 and the third end surface EF3 in the Z+ direction is zero to 5% of the length H1e of the rotor member 1e in the Z+ direction according to the rotor member 1e. In addition, the distance H24 between the second end surface EF2 and the fourth end surface EF4 in the Z+ direction is zero to 5% of the length H1e of the rotor member 1e in the Z+ direction. Thus, it is possible to suppress the occurrence of a tear or a crack in the hard magnetic body 3 according to the rotor member 1e.

### Second Embodiment

Hereinafter, a rotor member if according to a second embodiment of the present disclosure will be described with reference to the drawings. FIG. 19 is a sectional view of a rotor 10f. Regarding the rotor member if according to the second embodiment, only a portion different from those of the rotor member 1 according to the first embodiment will be described, and the other portions will not be described.

The rotor member if is used in an outer rotor type rotary electric machine, which is different from the rotor member 1. More specifically, an inner edge of the second end surface EF2 of the soft magnetic body 2 viewed in the Z+ direction surrounds an inner edge of the first end surface EF1 of the soft magnetic body 2 viewed in the Z− direction. In the outer rotor type rotary electric machine, the stator assembly 11 (not illustrated) is disposed around the shaft 4 and between the shaft 4 and the hard magnetic body 3 as viewed in the Z− direction.

The hard magnetic body 3 is disposed such that an outer edge of the hard magnetic body 3 coincides with a part of the inner edge of the soft magnetic body 2 as viewed in the Z− direction. That is, as illustrated in FIG. 19, an outer peripheral surface OS3 of the hard magnetic body 3 in the radial direction centered on the Z-axis is in contact with a part of the inner peripheral surface IS2 of the soft magnetic body 2 in the radial direction centered on the Z-axis. Thus, the hard magnetic body 3 is in contact with the inner peripheral surface IS2 of the soft magnetic body 2 in the radial direction centered on the Z-axis. In addition, the hard magnetic body 3 is not in contact with the outer peripheral surface OS2 of the soft magnetic body 2 in the radial direction centered on the Z-axis.

As illustrated in FIG. 19, a position of the first end surface EF1 of the soft magnetic body 2 in the Z+ direction is different from a position of the third end surface EF3 of the hard magnetic body 3 in the Z+ direction. More specifically, the first end surface EF1 is located in the Z+ direction with respect to the third end surface EF3. In addition, a position of the second end surface EF2 of the soft magnetic body 2 in the Z+ direction is different from a position of the fourth end surface EF4 of the hard magnetic body 3 in the Z+ direction. More specifically, the second end surface EF2 is located in the Z− direction with respect to the fourth end surface EF4.

The entire outer peripheral surface OS3 of the hard magnetic body 3 in the radial direction centered on the Z-axis is in surface contact with a part of the inner peripheral surface IS2 of the soft magnetic body 2 in the radial direction centered on the Z-axis as illustrated in FIG. 19. Therefore, the outer peripheral surface OS3 of the hard magnetic body 3 in the radial direction centered on the Z-axis is defined as the contact surface CS between the soft magnetic body 2 and the hard magnetic body 3 in the present embodiment.

As illustrated in FIG. 19, the contact surface CS between the soft magnetic body 2 and the hard magnetic body 3 has a shape protruding in a radial direction DIRR when the hard magnetic body 3 is in contact with the inner peripheral surface IS2 of the soft magnetic body 2. Here, the radial direction DIRR is the radial direction centered on the Z-axis. In the present embodiment, the contact surface CS between the soft magnetic body 2 and the hard magnetic body 3 has a shape that is curved to protrude in the radial direction DIRR.

As illustrated in FIG. 19, the width W1 in the radial direction centered on the Z-axis of a portion forming the contact surface CS in the soft magnetic body 2 at the position of the first end surface EF1 in the Z+ direction does not exist. In addition, the width W2 in the radial direction centered on the Z-axis of a portion forming the contact surface CS in the soft magnetic body 2 at the position of the second end surface EF2 in the Z+ direction does not exist.

The rotor member if as described above also has the same effects as the rotor member 1.

### Other Embodiments

The rotor member according to the present disclosure is not limited to the rotor members 1 and 1a to 1f, and can be modified within the scope of the gist thereof. In addition, structures of the rotor members 1 and 1a to 1f may be optionally combined.

It is sufficient that the rotary electric machine has a structure in which the rotor rotates by electricity or a structure in which electricity is generated as the rotor rotates. In this case, the rotary electric machine only needs to include at least any one of the rotor members 1 and 1a to 1f, and may include a brush.

The shaft 4 does not necessarily have a columnar shape. It is sufficient that the shaft 4 has a shape extending in the Z+ direction. Therefore, the shaft 4 may have, for example, a prismatic shape whose central axis is the Z-axis or an elliptical columnar shape whose central axis is the Z-axis.

The central axis of the soft magnetic body 2 may not coincide with the central axis of the shaft 4.

The soft magnetic body 2 does not necessarily have a cylindrical shape. It is sufficient that the soft magnetic body 2 has a tubular shape. Therefore, the soft magnetic body 2 may have, for example, a rectangular tubular shape or an elliptical cylindrical shape.

The central axis of the hard magnetic body 3 does not necessarily coincide with the central axis of the shaft 4.

The hard magnetic body 3 does not necessarily have a cylindrical shape. It is sufficient that the hard magnetic body 3 has a tubular shape. Therefore, the hard magnetic body 3 may have, for example, a rectangular tubular shape or an elliptical cylindrical shape.

The magnet which is one of the materials of the hard magnetic powder 31 is not limited to the neodymium magnet. The magnet which is the material of the hard magnetic powder 31 may be a rare earth magnet such as a samarium cobalt magnet, a praseodymium magnet, or a samarium iron nitrogen magnet. In addition, the magnet which is the material of the hard magnetic powder 31 is not limited to the rare earth magnet. The magnet which is the material of the hard magnetic powder 31 may be a ferrite magnet or the like.

In the rotor member 1e, the first end surface EF1 may be located in the Z+ direction with respect to the third end surface EF3. Also in this case, the same effects as those of the rotor member 1e are obtained if the distance H13 between the first end surface EF1 and the third end surface EF3 in the Z+ direction is zero to 5% of the length H1e of the rotor member 1e in the Z+ direction. In addition, in the rotor member 1e, the second end surface EF2 may be located in the Z− direction with respect to the fourth end surface EF4. Also in this case, the same effects as those of the rotor member 1e are obtained if the distance H24 between the second end surface EF2 and the fourth end surface EF4 in the Z+ direction is zero to 5% of the length H1e of the rotor member 1e in the Z+ direction.

In the rotor members 1 and 1a to 1d, the entire outer peripheral surface OS2 of the soft magnetic body 2 in the radial direction centered on the Z-axis is not necessarily in surface contact with the entire inner peripheral surface IS3 of the hard magnetic body 3 in the radial direction centered on the Z-axis. That is, it is sufficient that a part of the outer peripheral surface OS2 of the soft magnetic body 2 in the radial direction centered on the Z-axis is in contact with a part of the inner peripheral surface IS3 of the hard magnetic body 3 in the radial direction centered on the Z-axis.

Each of the first end surface EF1, the second end surface EF2, the third end surface EF3, and the fourth end surface EF4 may be a curved surface.

The contact surface CS between the soft magnetic body 2 and the hard magnetic body 3 may be a flat surface.

Each of the width W1, the width W2, the width W3, and the width W4 is not necessarily equal to the maximum width WMAX, which is the maximum of the width W in the radial direction centered on the Z-axis of the portion forming the contact surface CS in the soft magnetic body 2.

The method for manufacturing the rotor member 1 is not limited to the method for manufacturing the rotor member 1 described in the first embodiment. Regarding the rotor member 1, for example, the rotor member 1 may be manufactured by forming, in advance, a preliminary hard magnetic body 32a having a shape whose inner peripheral surface protrudes in the centripetal direction DIRC and a preliminary soft magnetic body 22a having a shape whose outer peripheral surface is recessed in the centripetal direction DIRC, and integrally molding the preliminary hard magnetic body 32a and the preliminary soft magnetic body 22a to form a main molded body. Alternatively, in the method for manufacturing the rotor member 1, for example, the rotor member 1 may be manufactured by forming, in advance, the preliminary hard magnetic body 32a having a shape whose inner peripheral surface protrudes in the centripetal direction DIRC, and integrally molding the preliminary hard magnetic body 32a and the soft magnetic powder 21 to form a main molded body.

The brushless motor 100 is not limited to the single-shaft type. The brushless motor 100 may be, for example, a double-shaft type.

It is sufficient that the material of each of the first housing 13a and the second housing 13b may be a material having high rigidity.

Each of the number of the plurality of tooth portions 14b, the plurality of coils 15, and the number of the plurality of insulating members 16 is not limited to nine. It is sufficient that each one of the plurality of coils 15 and each one of the plurality of insulating members 16 may be provided to correspond to each one of the plurality of tooth portions 14b.

The magnetic core 14 is not limited to being manufactured by laminating electromagnetic steel sheets. It is sufficient that the magnetic core 14 is a soft magnetic body.

In the rotor member 1c, the position in the Z+ direction at which the width W of the portion forming the contact surface CS in the soft magnetic body 2 in the radial direction centered on the Z-axis is the minimum width WMIN may be in the Z− direction with respect to the position in the Z+ direction of the intermediate surface IS.

In the rotor member 1d, the number of the positions in the Z+ direction at which the width W of the portion forming the contact surface CS in the soft magnetic body 2 in the radial direction centered on the Z-axis is the minimum width WMIN is not limited to two, and a plurality of positions may exist.

In the rotor member 1d, the positions in the Z+ direction at which the width W of the portion forming the contact surface CS in the soft magnetic body 2 in the radial direction centered on the Z-axis is the minimum width WMIN may exist only in the Z+ direction or only in the Z− direction with respect to the position in the Z+ direction of the intermediate surface IS.

In the rotor member if, the position of the first end surface EF1 of the soft magnetic body 2 in the Z+ direction may be equal to the position of the third end surface EF3 of the hard magnetic body 3 in the Z+ direction. In addition, the position of the second end surface EF2 of the soft magnetic body 2 in the Z+ direction may be equal to the position of the fourth end surface EF4 of the hard magnetic body 3 in the Z+ direction.

In the rotor member 1f, the width W1 in the radial direction centered on the Z-axis of the portion forming the contact surface CS in the soft magnetic body 2 at the position of the first end surface EF1 in the Z+ direction may exist. In addition, the width W2 in the radial direction centered on the Z-axis of the portion forming the contact surface CS in the soft magnetic body 2 at the position of the second end surface EF2 in the Z+ direction may exist. Also in these cases, it is sufficient that the position in the Z+ direction at which the width W is the minimum width WMIN is the position different from any of the position of the first end surface EF1 in the Z+ direction, the position of the second end surface EF2 in the Z+ direction, the position of the third end surface EF3 in the Z+ direction, and the position of the fourth end surface EF4 in the Z+ direction.

In the rotor member if, the contact surface CS between the soft magnetic body 2 and the hard magnetic body 3 may have a shape that is bent to protrude in the radial direction DIRR.

In the rotor member 1f, the position in the Z+ direction at which the width W of the portion forming the contact surface CS in the soft magnetic body 2 in the radial direction centered on the Z-axis is the minimum width WMIN may be different from the position in the Z+ direction of the intermediate surface IS.

In the rotor member 1d, there may be a plurality of the positions in the Z+ direction at which the width W of the portion forming the contact surface CS in the soft magnetic body 2 in the radial direction centered on the Z-axis is the minimum width WMIN.

It is sufficient that the contact surface CS between the soft magnetic body 2 and the hard magnetic body 3 is any surface where the soft magnetic body 2 and the hard magnetic body 3 are in contact.

The present disclosure has the following configurations.

(1) A rotor member used in a rotary electric machine, the rotor member including: a soft magnetic body having a tubular shape and comprised of soft magnetic powder, the soft magnetic body having a first end surface facing a first direction along a central axis of the soft magnetic body and a second end surface facing a second direction opposite to the first direction; and a hard magnetic body having a tubular shape and comprised of hard magnetic powder, the hard magnetic body having a third end surface facing the first direction and a fourth end surface facing the second direction, the hard magnetic body being in contact with a peripheral surface of the soft magnetic body in a radial direction centered on the central axis, wherein a contact surface between the soft magnetic body and the hard magnetic body has a shape protruding in the radial direction entirely around the central axis such that a first position in the first direction at which a minimum width of a portion forming the contact surface in the soft magnetic body in the radial direction is different from a second position of the first end surface in the first direction, a third position of the second end surface in the first direction, a fourth position of the third end surface in the first direction, and a fifth position of the fourth end surface in the first direction.

(2) The rotor member according to (1), wherein the peripheral surface of the soft magnetic body is an outer peripheral surface of the soft magnetic body, and wherein the contact surface has the shape protruding in a direction opposite to the radial direction.

(3) The rotor member according to (1) or (2), wherein the peripheral surface of the soft magnetic body is an inner peripheral surface of the soft magnetic body, and wherein the contact surface has the shape protruding in the radial direction.

(4) The rotor member according to any one of (1) to (3), wherein the contact surface has a curved shape protruding in the radial direction, or has a bent shape protruding in the radial direction.

(5) The rotor member according to any one of (1) to (4), in which a distance between the first end surface and the third end surface in the first direction is zero to 5% of a length of the rotor member in the first direction, and a distance between the second end surface and the fourth end surface in the first direction is zero to 5% of the length of the rotor member in the first direction.

(6) The rotor member according to any one of (1) to (5), in which a surface where a distance from the third end surface in the first direction is equal to a distance from the fourth end surface in the first direction is defined as an intermediate surface, and the first position in the first direction at which the minimum width of the portion forming the contact surface in the soft magnetic body in the radial direction is equal to a sixth position of the intermediate surface in the first direction.

(7) The rotor member according to any one of (1) to (5), in which a surface where a distance from the third end surface in the first direction is equal to a distance from the fourth end surface in the first direction is defined as an intermediate surface, and the first position in the first direction at which the minimum width of the portion forming the contact surface in the soft magnetic body in the radial direction is different from a sixth position of the intermediate surface in the first direction.

(8) The rotor member according to any one of (1) to (7), in which the first position in the first direction at which the minimum width of the portion forming the contact surface in the soft magnetic body in the radial direction is only one.

(9) The rotor member according to any one of (1) to (7), in which there are a plurality of the first positions in the first direction having the minimum width of the portion forming the contact surface in the soft magnetic body in the radial direction.

(10) The rotor member according to any one of (1) to (9), in which the contact surface is a curved surface and does not include a flat surface.

(11) The rotor member according to any one of (1) to (10), in which the tubular shape of the soft magnetic body is a cylindrical shape, and the tubular shape of the hard magnetic body is a cylindrical shape.

(12) The rotor member according to any one of (1) to (11), wherein the peripheral surface of the soft magnetic body is an outer peripheral surface of the soft magnetic body and the hard magnetic body is not in contact with an inner peripheral surface of the soft magnetic body.

(13) The rotor member according to any one of (1) to (12), in which a material of the soft magnetic powder contains iron and resin, and a material of the hard magnetic powder contains a magnet and resin.

(14) The rotor member according to (13), in which the magnet is a rare earth magnet.

(15) A rotor including: the rotor member according to any one of (1) to (14); and a shaft having a shape extending in the first direction, in which an outer peripheral surface of the shaft in the radial direction is in contact with an inner peripheral surface of the soft magnetic body.

(16) A rotary electric machine including the rotor member according to any one of (1) to (15).

(17) A brushless motor including the rotor member according to any one of (1) to (15).

(18) A method for manufacturing a rotor member, the method including: forming a preliminary hard magnetic body by compression-molding hard magnetic powder in which isotropic magnet powder and first binder powder are mixed; filling a die in such a manner that soft magnetic powder, in which iron powder and second binder powder are mixed, and the preliminary hard magnetic body are aligned in a radial direction centered on a central axis of the die and are in contact with each other after the forming of the preliminary hard magnetic body; and forming the rotor member by compression-molding the soft magnetic powder and the preliminary hard magnetic body from a first direction after the filling of the die, wherein a pressure for pressing the preliminary hard magnetic body is higher than a pressure for pressing the soft magnetic powder to form a rotor member having a soft magnetic body and a hard magnetic body in contact with each other.

(19) The method for manufacturing a rotor member according to (18), in which the forming of the rotor member includes a period in which a pressure for pressing each of the soft magnetic powder and the preliminary hard magnetic body is set to be higher than a pressure required for forming the soft magnetic body and lower than a pressure required for forming the hard magnetic body.

(20) The method for manufacturing a rotor member according to (18) or (19), in which the isotropic magnet powder is a rare earth magnet powder, the first binder powder is a resin, and the second binder powder is a resin.

### DESCRIPTION OF REFERENCE SYMBOLS

1, 1a, 1b, 1c, 1d, 1e, 1f, 6: Rotor member
2: Soft magnetic body
3: Hard magnetic body
4: Shaft
10, 10a, 10b, 10c, 10d, 10e, 10f, 20: Rotor
11: Stator assembly
12: Bearing
12a: First bearing
12b: Second bearing
13: Housing
13a: First housing
13b: Second housing
14: Magnetic core
14a: Core back portion
14b: Tooth portion
15: Coil
16: Insulating member
21: Soft magnetic powder
22a: Preliminary soft magnetic body
31: Hard magnetic powder
32, 32a: Preliminary hard magnetic body
100: Brushless motor
A1: Region
CS: Contact surface
D1, D2, DC, WC: Distance
DI: Die
DIRC: Centripetal direction
DIRR: Radial direction
E1: First end
E2: Second end
EF1: First end surface
EF2: Second end surface
EF3: Third end surface
EF4: Fourth end surface
IDI: Inner die
IS: Intermediate surface
IS1, IS2, IS3, ISIP, ISODI, ISOP: Inner peripheral surface
ODI: Outer die
OP: Outer punch
OP1: Opening
OS2, OS3, OS4, OSIDI, OSIP, OSOP: Outer peripheral surface
P: Punch
PO1: First position
S11, S12, S13, S14: Step
WMAX: Maximum width
WMIN: Minimum width

1. A rotor member used in a rotary electric machine, the rotor member comprising:
a soft magnetic body having a tubular shape and comprised of soft magnetic powder, the soft magnetic body having a first end surface facing a first direction along a central axis of the soft magnetic body and a second end surface facing a second direction opposite to the first direction; and
a hard magnetic body having a tubular shape and comprised of hard magnetic powder, the hard magnetic body having a third end surface facing the first direction and a fourth end surface facing the second direction, the hard magnetic body being in contact with a peripheral surface of the soft magnetic body in a radial direction centered on the central axis,
wherein a contact surface between the soft magnetic body and the hard magnetic body has a shape protruding in the radial direction entirely around the central axis such that a first position in the first direction at which a minimum width of a portion forming the contact surface in the soft magnetic body in the radial direction is different from a second position of the first end surface in the first direction, a third position of the second end surface in the first direction, a fourth position of the third end surface in the first direction, and a fifth position of the fourth end surface in the first direction.

2. The rotor member according to claim 1, wherein the peripheral surface of the soft magnetic body is an outer peripheral surface of the soft magnetic body, and wherein the contact surface has the shape protruding in a direction opposite to the radial direction.

3. The rotor member according to claim 1, wherein the peripheral surface of the soft magnetic body is an inner peripheral surface of the soft magnetic body, and wherein the contact surface has the shape protruding in the radial direction.

4. The rotor member according to claim 3, wherein the contact surface has a curved shape protruding in the radial direction, or has a bent shape protruding in the radial direction.

5. The rotor member according to claim 1, wherein
a distance between the first end surface and the third end surface in the first direction is zero to 5% of a length of the rotor member in the first direction, and
a distance between the second end surface and the fourth end surface in the first direction is zero to 5% of the length of the rotor member in the first direction.

6. The rotor member according to claim 1, wherein
a surface where a distance from the third end surface in the first direction is equal to a distance from the fourth end surface in the first direction is defined as an intermediate surface, and
the first position in the first direction at which the minimum width of the portion forming the contact surface in the soft magnetic body in the radial direction is equal to a sixth position of the intermediate surface in the first direction.

7. The rotor member according to claim 1, wherein
a surface where a distance from the third end surface in the first direction is equal to a distance from the fourth end surface in the first direction is defined as an intermediate surface, and
the first position in the first direction at which the minimum width of the portion forming the contact surface in the soft magnetic body in the radial direction is different from a sixth position of the intermediate surface in the first direction.

8. The rotor member according to claim 1, wherein the first position in the first direction at which the minimum width of the portion forming the contact surface in the soft magnetic body in the radial direction is only one.

9. The rotor member according to claim 1, wherein there are a plurality of the first positions in the first direction having the minimum width of the portion forming the contact surface in the soft magnetic body in the radial direction.

10. The rotor member according to claim 1, wherein the contact surface is a curved surface and does not include a flat surface.

11. The rotor member according to claim 1, wherein
the tubular shape of the soft magnetic body is a cylindrical shape, and
the tubular shape of the hard magnetic body is a cylindrical shape.

12. The rotor member according to claim 1, wherein the peripheral surface of the soft magnetic body is an outer peripheral surface of the soft magnetic body and the hard magnetic body is not in contact with an inner peripheral surface of the soft magnetic body.

13. The rotor member according to claim 1, wherein
a material of the soft magnetic powder contains iron and resin, and
a material of the hard magnetic powder contains a magnet and resin.

14. The rotor member according to claim 13, wherein the magnet is a rare earth magnet.

15. A rotor comprising:
the rotor member according to claim 1; and
a shaft having a shape extending in the first direction,
wherein an outer peripheral surface of the shaft in the radial direction is in contact with an inner peripheral surface of the soft magnetic body.

16. A rotary electric machine comprising the rotor member according to claim 1.

17. A brushless motor comprising the rotor member according to claim 1.

18. A method for manufacturing a rotor member, the method comprising:
forming a preliminary hard magnetic body by compression-molding hard magnetic powder in which isotropic magnet powder and first binder powder are mixed;
filling a die in such a manner that soft magnetic powder, in which iron powder and second binder powder are mixed, and the preliminary hard magnetic body are aligned in a radial direction centered on a central axis of the die and are in contact with each other after the forming of the preliminary hard magnetic body; and
forming the rotor member by compression-molding the soft magnetic powder and the preliminary hard magnetic body from a first direction after the filling of the die,
wherein a pressure for pressing the preliminary hard magnetic body is higher than a pressure for pressing the soft magnetic powder to form a rotor member having a soft magnetic body and a hard magnetic body in contact with each other.

19. The method for manufacturing a rotor member according to claim 18, wherein the forming of the rotor member includes a period in which a pressure for pressing each of the soft magnetic powder and the preliminary hard magnetic body is set to be higher than a pressure required for forming the soft magnetic body and lower than a pressure required for forming the hard magnetic body.

20. The method for manufacturing a rotor member according to claim 18, wherein
the isotropic magnet powder is a rare earth magnet powder,
the first binder powder is a resin, and
the second binder powder is a resin.
